(19) United States
(12) Patent Application Publication
(10) Pub. No.: US 2013/0288769 A1
(43) Pub. Date: Oct. 31, 2013

(54) SYSTEM AND METHOD FOR PROVIDING A BONUS GAME ANCILLARY TO A CASINO-STYLE MACHINE-BASED GAME

(71) Applicant: BRAIN GAMES, L.C., Dallas, TX (US)

(72) Inventors: Robert Hamman, Dallas, TX (US); Malcolm B. Davis, Dallas, TX (US); Fredrik Dahl, Loerenskog (NO)

(73) Assignee: BRAIN GAMES, L.C., Dallas, TX (US)

(21) Appl. No.: 13/871,646

(22) Filed: Apr. 26, 2013

Related U.S. Application Data
(60) Provisional application No. 61/638,844, filed on Apr. 26, 2012.

(51) Int. Cl. G07F 17/32

(52) U.S. Cl. CPC G07F 17/3293
USPC 463/18

(57) ABSTRACT

A method of operating a machine-implemented casino-style game includes receiving, with a game machine, a first wager from a human player of the machine-implemented casino-style game, the first wager entitling the human player to a payout if the human player wins the casino-style game, receiving a second wager from the player, the second wager entitling the player to view hidden indicia indicative of the status of machine-implemented game after the game is commenced and to receive a payout if the status of the machine-implemented game matches or exceeds a predetermined criteria, displaying to the player the hidden indicia indicating the position of the machine-implemented game and if the status of the machine-implemented game meets or exceeds the predetermined criteria, providing the human player with a payout.

### CROSS-REFERENCE TO RELATED APPLICATIONS

This application claims benefit of U.S. Provisional Application No. 61/638,844, filed Apr. 26, 2012, entitled SYSTEM AND METHOD FOR PRODIVING A BONUS GAME ANCILLARY TO A CASINO-STYLE MACHINE-BASED GAME (Atty. Dkt. No. BRGM-30476), the specification of which is incorporated herein in its entirety.

### TECHNICAL FIELD

The disclosure relates to machine-implemented casino-style games and, in particular to ancillary or bonus games that may be selected or offered to a human player in connection with a primary machine-implemented game such as a version of “Hold'em” poker. In one variation, the outcome of the bonus or ancillary game is determined by the private, (e.g., undisclosed to the human player) cards held by the machine-implemented game.

### BACKGROUND

Many casino-style games involve play where a player's position or game state is partially or totally hidden. For example, in a popular Hold'em type poker game, specifically “Texas Hold'em,” each player is initially dealt two private cards which are typically not revealed to the other player or players until the end of the hand when the remaining players show their hole cards to determine a winner of the hand. In the case of one machine-implemented game, the game initially “deals” the human player and itself two private cards which are typically visually represented on a screen.

The human player's private cards are revealed to the human player while the game's cards hidden from the human player. The machine-implemented game may be programmed such that the machine is unable to “see” the human player's private cards and decisions by the machine-implemented game may be based upon its hidden cards. If the human player or the machine-implemented game folds during the hand, the private cards of the winning player are typically not displayed.

In order to increase interest in a machine-implemented game such as a simplified version “Texas Hold'em” or a variant thereof, it may be desirable to incorporate an ancillary or bonus game based, at least in part, on the private or hole cards of the machine-based game. The ancillary game may require a separate wager by the human player or may be played in conjunction with the primary game. In one variation, the human player may place a wager based upon the undisclosed private cards of the machine-based game. A human player may view or perceive such an ancillary or “bonus” game as an additional opportunity to wager and possibly win, even if the human player elects to fold his or her hand during the course of play. The human player may also want to see the private cards of the machine-based game in the event that he or she folds during the course of the hand in an attempt to deduce the strategy employed by the machine-based game.

### SUMMARY

In one embodiment, a method of operating a machine-implemented casino-style game includes receiving a first wager from a human player of the machine-implemented casino-style game, the first wager entitling the human player to a payout if the human player wins the casino-style game. The human player may place a second wager, entitling the player to view hidden indicia indicative of the status of a machine-based game after the game is commenced and to receive a payout if the status of the machine-based game matches or exceeds predetermined criteria. The hidden indicia may comprise visual representations of standard playing cards from a standard deck, e.g., hearts, spades, clubs and diamonds. The machine-based or machine-implemented game displays visual representations of the randomly selected indicia indicating a status or game state of the human player's position in the game.

As used herein, the term “game state” refers to the “cards” representing the position of the human player and the machine-based game. For example, in a “Hold'em” style poker game, the machine-implemented game may deal the human player two randomly selected private cards, for example, a king of hearts and queen of spades which represents the game state of the human player's hand after the private cards are dealt. The game state of the human player and the machine will, of course, change as additional cards are dealt during the course of the game.

The method includes receiving a signal from the human player transmitted via an interface, the signal indicating that the human player wishes to terminate play of the hand and view hidden indicia indicative of the status or game state of the machine-based game, specifically hidden indicia not previously disclosed to the human player. In this embodiment, the hidden indicia, e.g., private cards of the machine-implemented game, are displayed to the human player. If the status or game state of the machine-implemented game meets or exceeds predetermined criteria, the human player will be provided with a payout. For example, the predetermined criteria may be that the private cards of the machine-implemented game are the same or different colors. If the human player folds and the private cards of the machine-implemented game meet the predetermined criteria, the human player may be entitled to a payout.

In one aspect, the hidden indicia comprise representations of standard playing cards displayed by the machine-based game on a display associated with the machine-based game. The primary machine-based game may be a form of poker and more particularly, a “Hold'em” variety of poker where the machine-based game and the human player are each dealt randomly selected private cards and community cards from which the best hand is determined. If the human player elects to play the ancillary game, the representations of the private cards of the machine-based game may be displayed to the human player after the human player terminates play by folding or at the end of the game. For example, if the human player has placed a wager in connection with the ancillary or bonus game and is dealt private cards that the human player perceives to present little opportunity to win the primary game, the human player may fold, believing that he or she has a better opportunity to win the ancillary game rather than continue with the primary game.

In another aspect, a system for simulating a machine-implemented casino-style game includes at least one electronic game machine including a display device for displaying indicia representative of a game state for the human player and for the machine-implemented game. In one aspect, the machine-implemented game is poker and the displayed indicia are visual representations of playing cards.

The electronic game machine also includes an interface for receiving an input from a human player of the game and a storage device for storing a game algorithm. The electronic game machine may also include a processor operative with the storage device to implement the game algorithm and operative with the display device to display indicia representative of a game state. The game machine may be configured to play a primary casino-style machine-based game such as poker with the human player and a second, ancillary game. The outcome of the primary casino-style game is based upon a combination of displayed indicia visible to the human player and accessible to the game machine and hidden indicia whereby the hidden indicia of the machine-based game is not displayed to the human player during play. The hidden indicia, typically private cards of the machine-based game, are typically not displayed to the human player if the human player terminates play of the game, e.g., folds unless the human player has participated in the ancillary game.

In this regard, the electronic game machine may be configured to receive at least one wager from the human player entitling the human player to a payout if the player wins one of the primary casino-style game and the ancillary game. In different embodiments, the game machine may be configured to receive separate wagers for the primary game and the ancillary game. The result or outcome of the ancillary game is based upon the hidden indicia representative, at least in part, of the game state of the machine-based game. The system may include a central processor connected to the electronic game machine, the central processor operative to receive an input from the electronic game machine corresponding to the outcome of games played on the electronic game machine. A data interface may be provided between each of the electronic game machines and the central processor such that the status and/or outcome of games played by human users of the game machine are transmitted to the central processor.

### BRIEF DESCRIPTION OF THE DRAWINGS

For a more complete understanding, reference is now made to the following description taken in conjunction with the accompanying drawings in which:

FIG. 1 illustrates a simplified game of Texas Hold'em poker;

FIG. 2 is a schematic representation of a gaming system suitable for use in connection with the method disclosed herein, the system including a central office and a plurality of electronic game machines;

FIG. 3 illustrates an electronic game machine suitable for use in the system of FIG. 2;

FIG. 4 is a block diagram illustrating one configuration of an electronic game machine suitable for use in the system of FIG. 2;

FIG. 5 is a flowchart, illustrating a method of incorporating an ancillary or bonus game with a primary, machine-implemented, casino-style game according to the disclosure;

FIG. 6 is a representation of an exemplary display for prompting human players of a machine-implemented casino-style game to play an ancillary or bonus game;

FIG. 7 is a flowchart, illustrating a method of incorporating an ancillary or bonus game with a primary, machine-implemented, casino-style game according to the disclosure; and

FIGS. 8A-8C are exemplary screen displays, illustrating different game states in accordance with a method of the disclosure.

### DETAILED DESCRIPTION

Referring now to the drawings, wherein like reference numbers are used herein to designate like elements throughout, the various views and embodiments of a system and method for providing a bonus game ancillary to a casino-style machine-based game are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

Suitable games for implementation in connection with a machine-based gaming system and method as disclosed herein include various different poker games. The casino or game system operator is represented by an electronic game machine suitable for implementing and playing the game. As used herein, the term “game machine” is used to refer to electronic game machines of the type used in casinos. The terms “machine-based game” and “machine-implemented game” refer to games played on such electronic game machines. The electronic game machines are typically designed to accept a wager in the form of value from a human player in exchange for playing a game of chance. As used herein, the term “wager” means value in the form of currency, credits recorded or debited on a stored value card, tokens, tickets, etc., which have a value that may be expressed in terms of currency. The value may be in the form of cash, game tokens, game tickets, a credit card or stored value card. After receiving the value, the game is played and the machine may dispense value in the form of a prize, i.e., a “payout” depending on the result of the game. The payout may be in the form of currency, a credit to a stored value card, a token or a ticket redeemable for currency or other value.

One variant of Hold'em poker is “Texas Hold'em,” which is widely considered one of the most strategically complex variants. Texas Hold'em utilizes a standard 52-card deck and there are typically four betting rounds. In the first round, the players are dealt two private cards. “Blind” bets are used to start the first round. The first player (in the position of the “small blind”) typically begins the hand with a set number of units in the pot and the second player (in the position of the “big blind”) continues with a bet of 2× the set number of units.

In the second round (or flop), three board or community cards are revealed followed by a betting round. In each of the third round (turn) and fourth round (river), a single board card is revealed followed by a betting round. A fixed-bet maximum may be used, with fixed raise amounts of X units in the first two rounds and Y units in the final two rounds. In other “no-limit” variations, a player may wager as much as he or she wishes in the betting rounds.

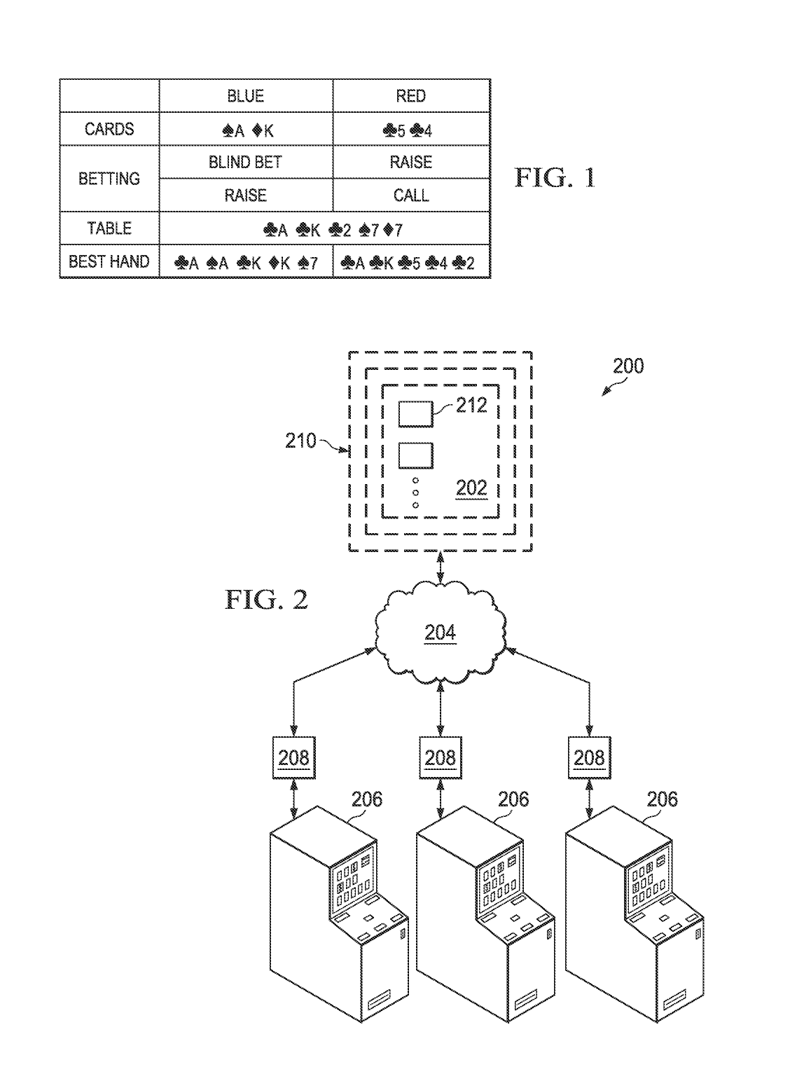

A simplified example of a “heads up,” (i.e., two player) Hold'em game suitable for adaptation as a machine-based game may proceed as illustrated in FIG. 1. A deck of 52 cards is shuffled (e.g., randomly arranged). Two private cards are dealt to each player (hereafter named Blue and Red). Blue then makes a forced blind bet of one unit, whereafter Red has the options of folding, calling and raising (by one unit). The betting process continues until one player folds or calls, except that Blue has the right to bet if Red calls the blind bet (the blind is “live”). The human player (Blue) then makes a forced blind bet (“small blind”) of one unit, after which the machine-implemented game (Red) has the options of folding, calling and raising (by one unit). The betting process based on the private cards may continue until one player (the human or the machine) folds or calls. The number of raises may be limited to control the pot size and expedite the game. The human player (or the machine-based game) loses the pot, e.g., the accumulated bets or wagers, to the opponent if he folds.

Assuming that the betting based on the private cards stops with a call, five community or common cards, called the table, are dealt. At this point, the human player and the machine-based game each have seven cards, two private and five community cards, from which the best five card hand may be determined. The best five card hand wins the pot. In the example illustrated in FIG. 1, the player designated as “Red” wins three units from the player designated “Blue,” because the Red player's flush defeats the Blue player's two pair. Numerous variations and permutations of the game rules are possible.

In one embodiment of the method disclosed herein, the human player is provided the option of playing an ancillary or bonus game in addition to the primary game of “Hold'em” poker. The player may elect to place a wager or side bet based upon the private cards of the machine-based game. The wager or side bet may be that the machine-based game's private cards are the same color, (e.g., red or black), different colors, the same suit (e.g., hearts, clubs, spades or diamonds) or that the machine-based game's cards meet a specific criteria, for example a pair of cards having a specified rank, for example, greater than a pair of tens.

In one embodiment, the human player may be required to place a side or secondary wager before the machine-based game deals the private cards. For example, if the blind bet is one dollar, the human player may be required to wager an additional one dollar to participate in the ancillary game. In other embodiments, the game machine or system may be programmed to incorporate the ancillary game whereby, when the human player wagers the blind bet, the player is automatically eligible to participate in the ancillary game. In yet other embodiments, the amount of the human player's potential win in the primary game may be limited or reduced if he or she elects to participate in the ancillary game. For example, a human player that elects to play the ancillary game may have his or her payout (in the event that player wins the primary game) reduced by a predetermined percentage, for example, by 10 percent.

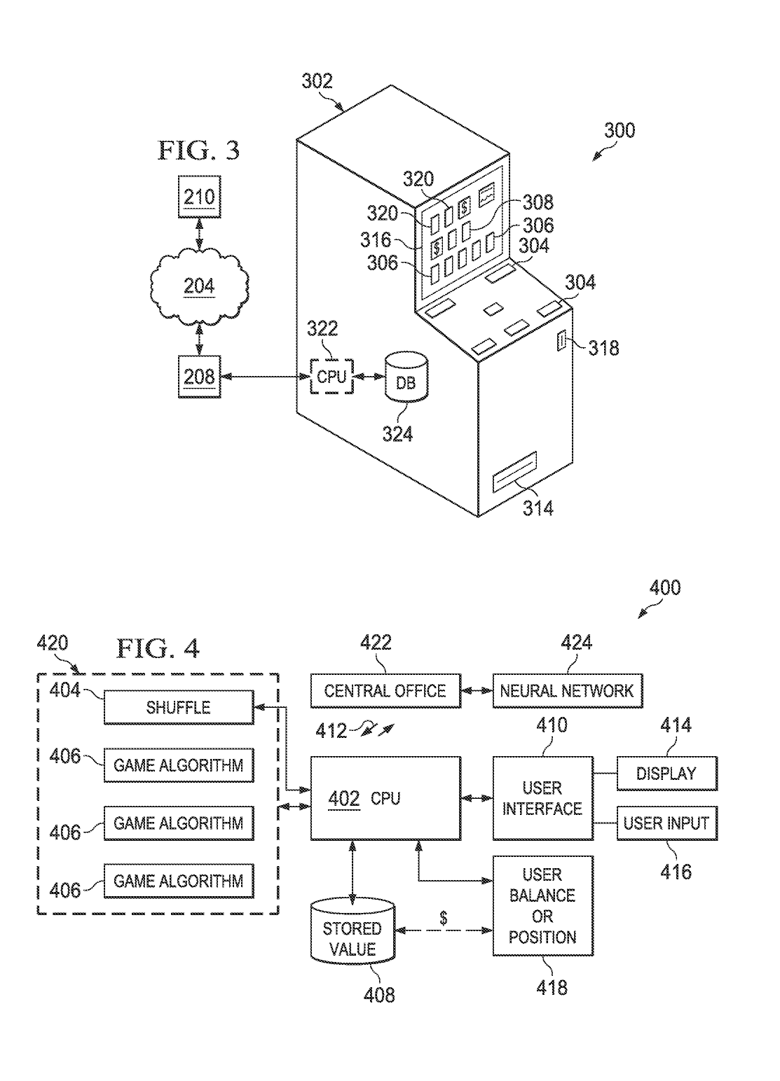

FIG. 2 is a block diagram illustrating a system 200 for implementing a game such as “Hold'em” poker in a casino-style gaming environment. System 200 may include a number of game machines 206 operatively connected to a central office 210. Central Office 210, in one embodiment, includes a dedicated game engine 202. Central office 210 may be located remote from game machines 206 and may control game machines located in multiple remote locations. A network 204, such as a wired Local Area Network (LAN) or a public or private wireless network may be used to route communications between central office 210, game engine 202 and game machines 206. A plurality of data interfaces 208 may be utilized for security purposes and to facilitate communications between game machines 206 and central office 210. Data interfaces 208 are typically hardware devices sufficient to support communications between game machines 206 and central office 210.

In one variation, game engine 202 may employ one or more Application Specific Integrated Circuits (ASICs) with specific preprogrammed instructions hard-wired or burned into non-volatile memory to implement the methods described herein. In different embodiments, engine 202 may include a combination of preprogrammed software along with dedicated hardware and firmware to implement the methods. In yet other embodiments, engine 202 may be programmable using a remote device. One or more physical security measures generally indicated at 212 may be employed to maintain the integrity of engine 202 and to prevent tampering. Such measures may include locating engine 202 in a locked room or enclosure, and/or using alarms, motion detectors, proximity sensors or similar devices to prevent unauthorized access to engine 202.

Referring still to FIG. 2, central office 210 may be connected to game machines 206 via a network 204 and device interfaces 208. Interfaces 208 include hardware and software sufficient to provide communications between engine 202 and electronic game machines 206. Network 204 may be a hard-wired or wireless Local Area Network (LAN), a Wide Area Network (WAN) or the Internet. In this embodiment, game machines 206 may be located at the same or different locations. For example, game machines 206 may be located at different locations in an establishment such as a casino, in different casinos, or similar establishments, at geographical diverse locations and operatively connected to engine 202 via a network 204 as described above. In other embodiments, game machines 206 may be personal computers, smart phones or other similar devices adapted to connect to the Internet. In these variations, central office 210 may be a web server, programmed to display a webpage promoting the game and to play the game against human players utilizing personal computers, tablet computes, smart phones and similar devices to access the central office. Transmissions between engine 202 and electronic game machines 206 may be encrypted using known techniques such as TSL or SSL protocols to prevent hacking or unauthorized access to the engine 202 and game machines 206.

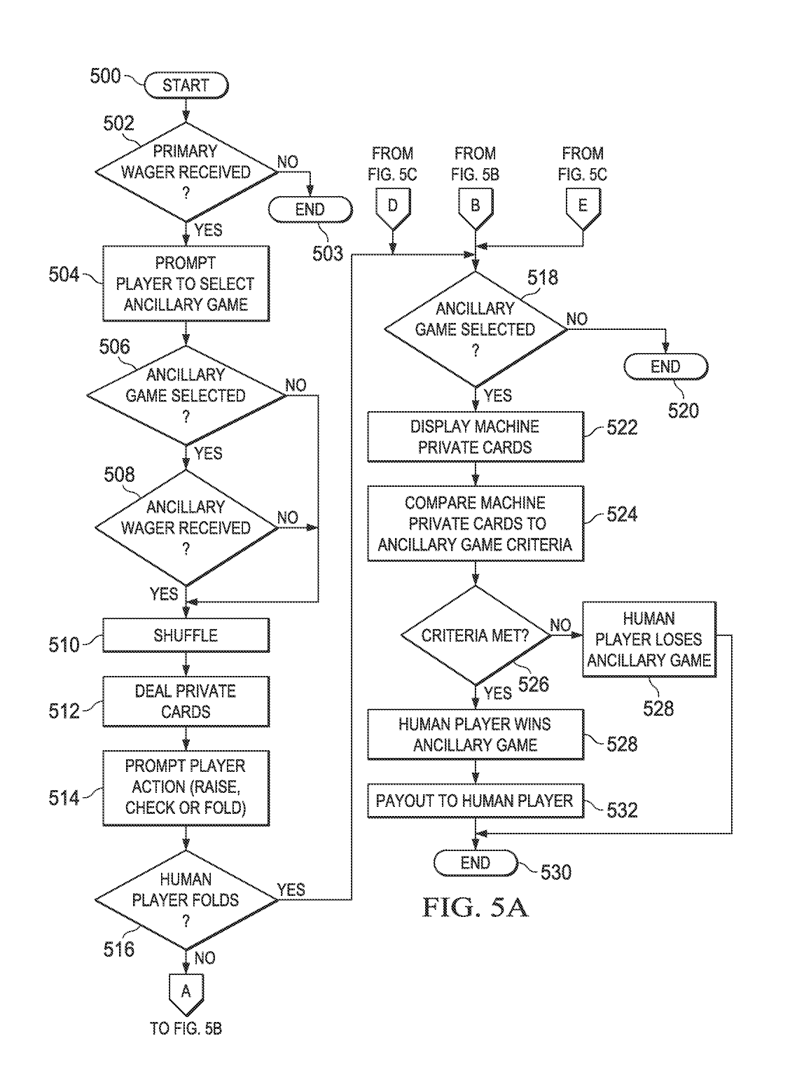

Referring now to FIG. 3, there is illustrated a diagrammatic view of an electronic game machine 300, similar or identical to machine 206 of FIG. 2, suitable for use in a system and method for implementing a machine-based casino-style game. Machine 300 includes a chassis 302 for mounting a display 316 and one or more user interfaces 304 that allows a human user to interact with the system. User interfaces 304 may include features such as a graphical touch screen, a keyboard, buttons, levers, or switches that enable the user to interact with the machine-implemented using game machine 300. Display 316 may further comprise a graphical user interface, providing one or more additional user interfaces. User input will typically be based on a decision to take an action. In the case of a machine-implemented poker game, the action may be to place a bet, raise, call/check or fold.

In different embodiments, electronic game machine 300 is provided with a payment input device 314 enabling a human player to wager by entering value via the payment input device. The payment input device 314 may be a card reader, token reader, or similar device that permits a human player to use a credit card, debit card, smart card, bar coded ticket or other stored value card or token to place a wager. In one embodiment, a stored value card is used to record and store a player's position, e.g., the value of the player's position in currency or wagering units. This feature allows a player to go from one machine to another to play different casino-style machine-based games. Machine 300 may also include a cash, ticket or token dispenser 318 to provide payments or dispense tokens or tickets to the user. In the case of an Internet based game, central office 210 may be adapted to receive wagers by means of a credit card, deposit account or other payment means typically used for online payment.

Display 316 provides a human player a visual interface with the electronic game machine 300. Display 316 may show an indicia representative of a game state, for example a simulation of the cards in play. By way of example, in accordance with a machine-implemented simplified heads up “Texas Hold'em” game as described in connection with FIG. 1, the display may display the human player's two private cards 308. The human user's private cards 308 will be displayed to the human player, but the machine-implemented game itself has no access to the human's private cards. Thus, actions by the machine-implemented game are determined by the private cards of the game without consideration of the human player's private cards. The private cards 320 of the machine-based game will appear to the human user on display 316 as if the cards were turned down, but electronic game machine 300 will have access to the information associated therewith. Community cards 306 will be displayed to the human user and will be known by machine 300. During play, the human player may select various actions, i.e., raise, fold, check or call, using one or more user interface devices 304.

In one embodiment, a player's position, e.g., the value of the player's position in currency or in available wagering units may be presented on display 316. In different variations, game machine 300 may incorporate a dedicated processor 322 along with an associated database 324 operatively connected to the processor. In this embodiment, game machine 300 may be a stand alone unit.

Game machine 300 may be monitored by central office 210 to monitor the game results and for audit and accounting purposes. Different machine-implemented games may be downloaded from central office 210 to processor 322 and/or stored on database 324, enabling electronic game machine 300 to play selected games on a stand alone basis. In other variations, the operation of game machines 300 may be directly controlled by central office 210 during play.

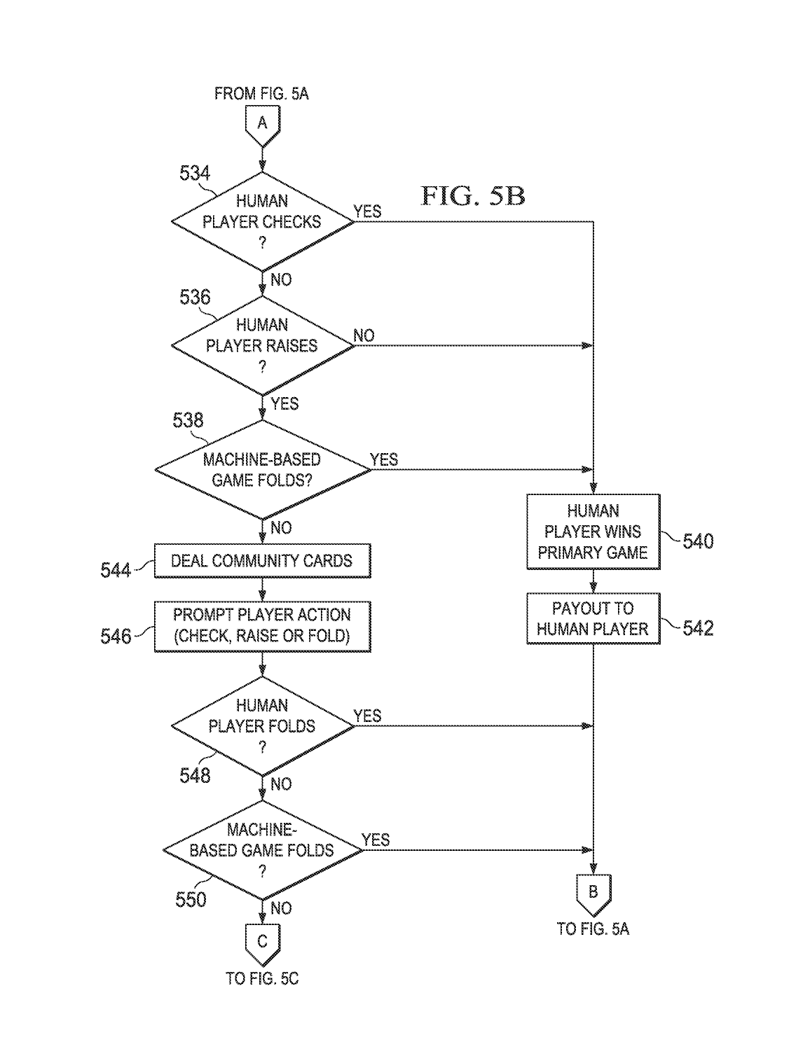

FIG. 4 is a block diagram schematically illustrating one configuration of an electronic game system 400 that may be implemented on a game machine such as machine 300 of FIG. 3. As illustrated, a plurality of algorithms such as a shuffle algorithm 404 and game algorithms 406, corresponding to different games and actions available on the machine, are stored on database 420. Processor 402 may access the different algorithms 404, 406 in response to user input 416 received via user interface or interfaces 410 to take various actions. Such actions may be in response to an action by a human player during play. For example, the machine-implemented game may call or fold in response to a raise by a human player.

Processor 402 may interface with a stored value module 408 such as a magnetic card read/write module for maintaining and updating the player's position 418 on a stored value card or similar device. This enables a player to leave the game at his or her discretion by removing the card and then, if desired, return to continue play at a later time. Processor 402 maintains a record of the player's position 418, debiting or crediting the player's position in currency or wagering units. The human player's position 418 may be stored on a stored value module 408 and/or displayed to the player with display 414. Processor 402 may communicate the player's identity, the player's position, the identity and status of the game in play and other information to a central office unit 422, continuously or at periodic intervals, via a data interface represented by arrows 412.

Processor 402 may interface with and use one or more neural networks 424 along with a selected game algorithm 406. In one embodiment, processor 402 is operable to execute a game algorithm 406 which plays a selected game, for example a “Texas Hold'em” poker game. The output of neural networks 424 may be a probability distribution for certain actions, i.e., there are a number of actions associated with a neural network. The various actions may each of which have a probability distribution associated therewith. The neural networks may be “trained” to associate the probabilities of different outcomes based on particular game states. The machine-based game may utilize probability distribution(s) to determine actions that may be taken by system 400 during play, e.g., to fold, call/check or raise. Game algorithm(s) 406 may also be designed and programmed to introduce a random component or factor in order to prevent predictable responses on the part of the machine-based game.

Referring still to FIG. 4, different games, such as poker, will also have associated therewith some type of “shuffle” algorithm or program 404 that will shuffle, i.e., randomly arrange the cards used in the game. For example, shuffle algorithm 404 may use a random or pseudo-random number generator to simulate a shuffle of a 52-card deck and select cards for the game. As previously noted, game algorithms 406 may rely on one or more neural networks 424 to enable system 400 to play the corresponding game.

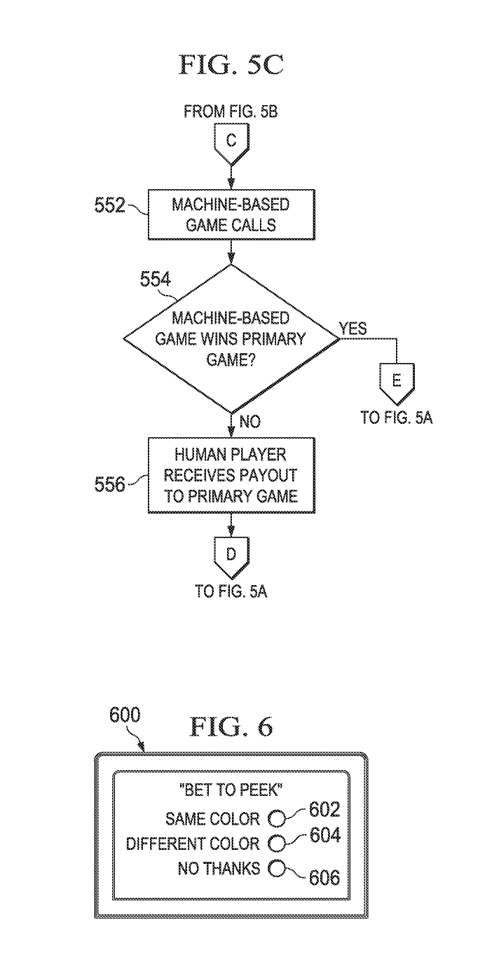

FIG. 5 is a flowchart illustrating one embodiment of a machine-based gaming method including a primary game and an ancillary game associated with the primary game wherein the game involves hidden positions; in this embodiment, a “Texas Hold'em” game where the hidden positions are the private cards of the human player and the machine-based game. The game begins at step 500 with the placement of a wager by the human player at step 502. If the player fails to place a wager on the primary game, e.g., the “Texas Hold'em” game, the process terminates at 503. Assuming that the human player places a wager at step 502, the game machine prompts the human player at step 504 to determine if the player wishes to play an ancillary or bonus game, for example to place a wager based upon the color of the private cards of the machine-based game.

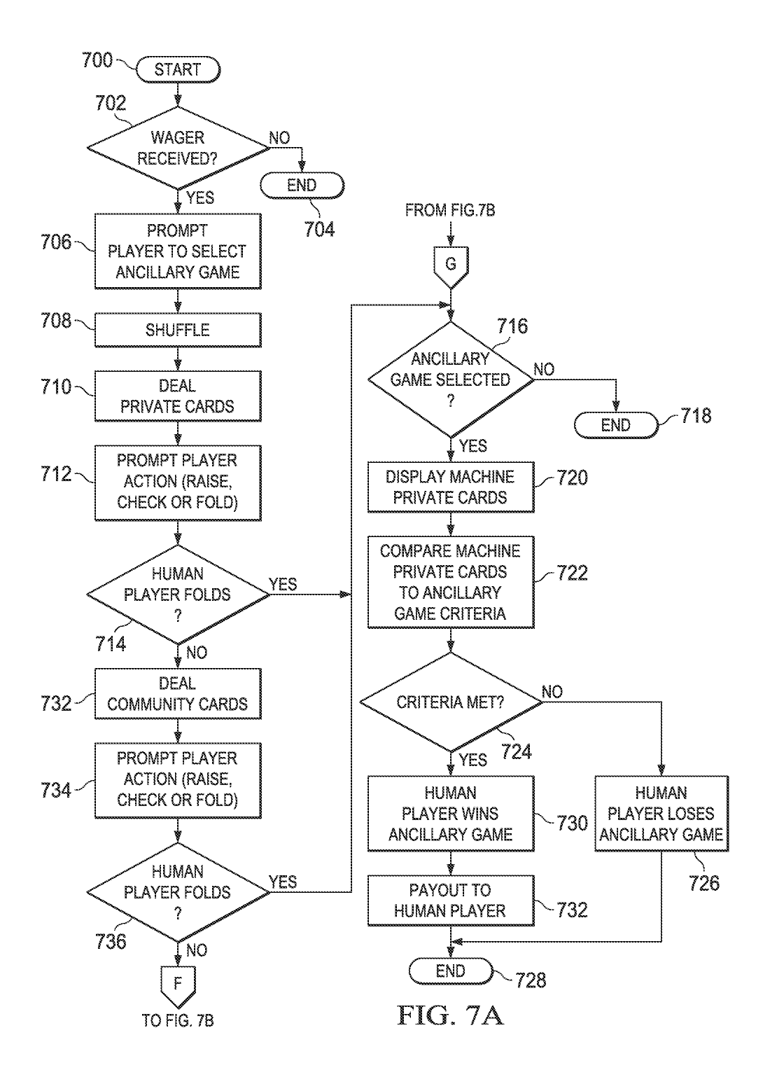

FIG. 6 is an exemplary screen 600 displaying the prompt “Bet to Peek” whereby the human player may elect to wager on an ancillary game. For example, the human player may place a wager that the private cards of the machine-based game will be the same color, for example two hearts and/or diamonds or spades and/or clubs, or different colors, a heart or a diamond with a spade or a club. The human player may elect to wager by pressing buttons 602 or 604 or decline by pressing button 606. If the human player declines to play the ancillary game, the process loops to step 510 of FIG. 5 and the primary game is played to conclusion as described above.

Referring again to FIG. 5, the human player may elect to play the ancillary game at step 506 and place a wager on the ancillary game at step 508. In one embodiment, the odds of the machine-based ancillary game are biased in favor of the machine operator or the proprietor of the establishment where the machine is located to provide the game operator with an incentive to offer the ancillary game to human players. For example, the odds of the machine-based game winning the ancillary game may be 11:10, wherein the machine-based game is programmed to pay out $10 for every $11 received in wagers on the ancillary game. In other embodiments, the odds of the machine-based game winning the ancillary game may be 20:19 or another ratio that provides the operator of the machine-based game an incentive to offer the ancillary game to human players. In yet other embodiments, the ancillary or bonus game may be automatically associated with the primary game such that ancillary or bonus game is available to the human player upon his or her wager on the primary game.

Referring still to FIG. 5, at step 510, the machine-based game “shuffles” a deck of 52 cards by means of an algorithm or program 404 (FIG. 4) that randomly arranges the cards and then at step 512, “deals” private cards to itself and to the human player. After dealing the private cards, the machine-based game may prompt the human player to take an action, e.g., check, raise or fold at step 514.

If the human player elects to fold at step 516, the machine-based game checks to determine whether the human player has elected to play the ancillary game at step 518. If the human player has not elected to play the ancillary game, the process ends at step 520; however, it is unlikely that a human player would fold at this stage unless he or she had placed a wager on the ancillary game.

If the human player folds at step 516, the machine displays its private cards to the human player at 522 and compares, at step 524, its private cards to the predetermined criteria associated with the ancillary game, for example if the cards are the same or different colors and determines at step 526 whether the criteria is met. If the predetermined criteria is not met, the human player loses the ancillary game at 528 and the process ends at 530. If the criteria is met, the human player wins the ancillary game and receives the payout associated with the ancillary game at step 532 and the process ends at 530.

Returning to step 516, if the human player does not fold, he or she may check, at step 534 or raise, at step 536. At step 538, the machine-based game may fold, check or match a raise by the human player. In different embodiments, the machine-based game may also raise. In this embodiment, the human player must match the raise of the machine-based game to continue playing. If the machine-based game folds, the human player wins the primary game at step 540 and receives a payout for the primary game at step 542 after which the process returns to step 518 to determine whether the human player has won the ancillary game in addition to the primary game.

If the machine-based game does not fold at step 538, e.g., the machine-based game matches any raise made by the human player and/or calls, the game deals the community cards at step 544. At step 546, the machine-based game prompts the human player to take action, e.g., check, raise or fold. If the human player elects to fold at step 548, the process loops back to step 518 to determine whether the human player has won the ancillary game. If the human player elects to raise or check the machine-based game, the machine-based game may fold or call at step 550. If the machine-based game folds at step 550, the human player wins the primary game, and the process loops back to step 518 to determine whether the human player also wins the ancillary game.

If the machine-based game does not fold, at step 552, the machine-based game calls. If the machine-based game wins the primary game at step 554, the process loops back to step 518 to determine whether human player wins the ancillary game. If the machine-based game loses the primary game, at step 556 the machine-based game dispenses a payout to the human player and the process then loops back to step 518 to determine if the human player also wins the ancillary game.

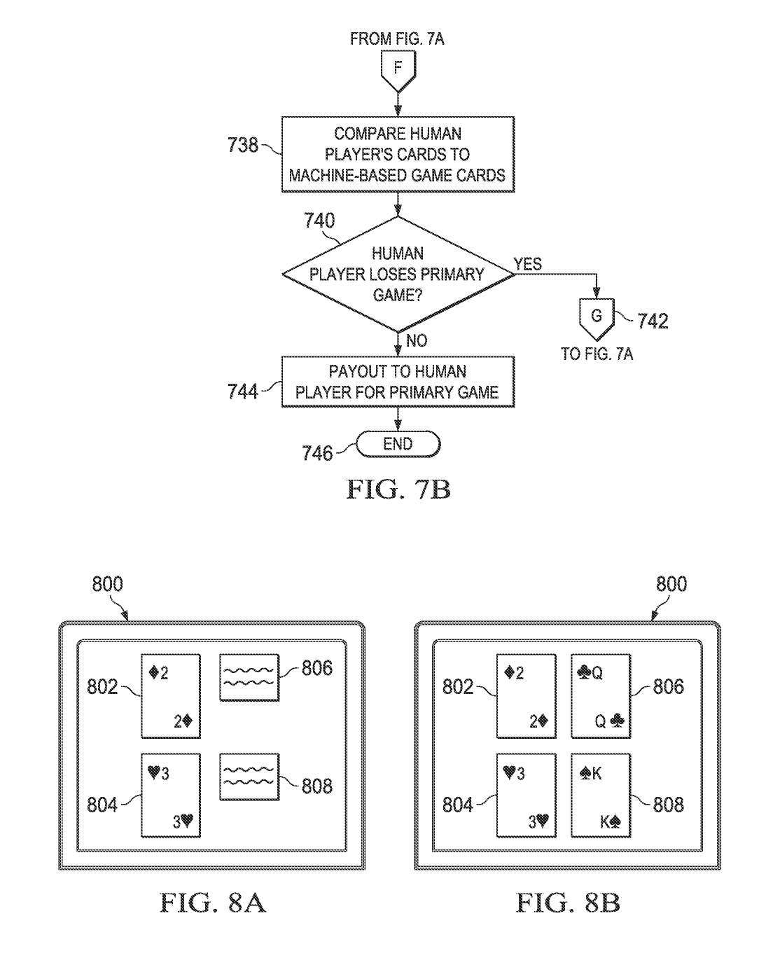

FIG. 7 is a flowchart illustrating another embodiment of a machine-based gaming method including a primary game and an ancillary game associated with the primary game. The method begins at step 700 where a human player commences play. At step 702, the human player may place a wager on a primary game such as “Hold'em” poker. If the machine-based game does not register a wager by the human player within a predetermined time, the process ends at step 704. If the wager is received, the machine-based game may prompt the player at step 706 to determine if the human player wishes to play an ancillary or bonus game, for example, placing or allocating a portion of his or her wager on the private cards of the machine-based game. The outcome of the ancillary game may be determined by whether the private cards of the machine-based game are the same color, the same suit, or have a particular value such as a pair or other predetermined criteria. For the purpose of this example, the criteria may be that the private cards are the same color.

In other variations, the human player may be required to forego a portion of possible winnings or payouts of the primary game in order to participate in the ancillary game. In other embodiments, the machine-based game may be configured such that the primary game and the ancillary game are played simultaneously, without a penalty or deduction from a possible payout from the primary game. In such embodiments, the step (706) of prompting the human player to play the ancillary or bonus game may be omitted.

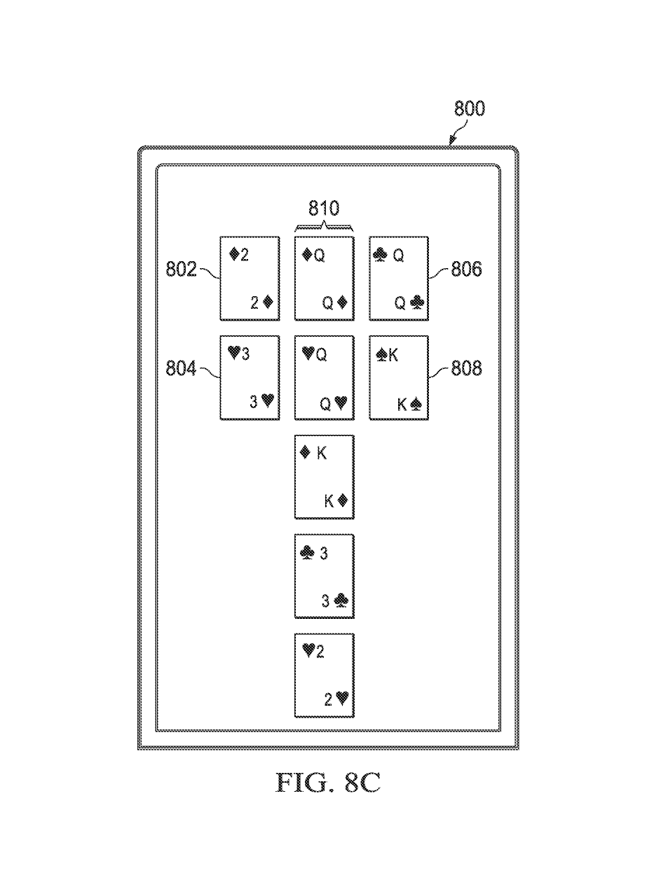

At step 708, the machine-based game shuffles, e.g., randomly arranges a simulated deck of playing cards, and at step 710 “deals” private cards to the human player and to itself, displaying the human player's cards to the human, but displaying its cards “face down.” FIG. 8A is an exemplary screen display 800 illustrating one possible game state after the simulated private cards are dealt. The human player has been dealt a two of diamonds and a three of hearts 802, 804, which are displayed to the human player. The private cards 806, 808 of the machine-based game are displayed “face down” and not revealed to the human player.

Depending upon the particular embodiment, the human player may then be prompted to take an action, e.g., raise, check or fold at step 712. If the human player perceives that he or she has a weak position, and has opted to play the ancillary game, he or she may elect to fold at step 714. At step 716, the machine-based game confirms that the human player has elected to participate in the ancillary game. If not, the process ends at step 718. If the human has elected to participate in the ancillary game the process proceeds to 720, where the private cards of the machine-based game are displayed to the human player. FIG. 8B is an exemplary screen display 800 illustrating a possible game state after the human player folds. The private cards 806, 808 of the machine-based game are displayed. The private cards of the machine-based game are compared to the predetermined criteria at step 722, in this case the cards must be the same color for the human player to win the ancillary game. In this example, the predetermined criteria (same color) is met and determined at step 724. The machine-based game determines that the human player has won the ancillary game at 730 and provides the human player with the payout associated with the ancillary game at 732. Alternatively, it the predetermined criteria is not met, the human player loses the ancillary game at 726 and the process ends at 728.

Returning to FIG. 7, step 718, if the human player calls (or raises) in response to the prompt, the machine-based game “deals,” e.g., “deals” displaying five randomly selected community cards at step 732. In the case of a Texas Hold'em game, the community cards may be dealt in stages, e.g. the “flop” “turn” and “river” with a round of betting at each stage.

FIG. 8C is an exemplary screen display 800 illustrating a possible game state after the machine-based game has displayed the community cards 810. In the illustrated example, the community cards are a queen of diamonds, a queen of hearts, a king of diamonds, a three of clubs and a 2 of hearts. At step 734 the machine-based game may prompt the human player to take action, (check, raise or fold). If the human player elects to fold at 736, the process returns to step 716 to determine if an ancillary game was selected by the human player, and if so, whether the human player won the ancillary game.

Alternatively, if the human player elects to raise or check, the human player's cards are compared to the cards of the machine-based game at step 738. The winner of the primary game is determined at step 740. Referring again to FIG. 8C, in this example, the human player loses since the machine-based game has a superior hand, a full house with three queens and two kings, whereas the best hand that the human player can assemble from his or her private cards and the community cards is two pair, threes and queens. In this example, the process loops back at step 742 to step 716 to determine whether the human player has elected the ancillary game and to determine whether he or she won the ancillary game.

Alternatively, if the human player wins the primary game at step 740, he or she is provided with the payout for the primary game at step 744 and the process ends at step 746. In this embodiment, the human player is not provided with an opportunity to play/win the ancillary game since he or she has won the primary game. In different embodiments, a human player winning the primary game may be allowed to play the ancillary game, in which case, the process loops back to step 716.

It will be appreciated by those skilled in the art having the benefit of this disclosure that this system and method for providing a bonus or ancillary game to a casino-style machine-based game provides a means of increasing interest in the casino-style game and increasing the desirability of the game to human players. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method of operating a machine-implemented casino-style game comprising:
receiving, with a game machine, a first wager from a human player of the machine-implemented casino-style game, the first wager entitling the human player to a payout if the human player wins the casino-style game;
receiving, with the game machine, a second wager from the player, the second wager entitling the player to view hidden indicia indicative of the status of machine-implemented game after the game is commenced and to receive a payout if the status of the machine-implemented game matches or exceeds a predetermined criteria;
providing a display of randomly selected indicia indicating a status of the human player's position in the game;
receiving with the game machine, a signal from the human player transmitted via an interface, the signal indicating that the human player wishes to terminate play of the game and view hidden indicia indicative of the status of the machine-implemented game;
displaying to the player the hidden indicia indicating the position of the machine-implemented game; and
if the status of the machine-implemented game meets or exceeds the predetermined criteria, providing the human player with a payout.

2. The method of claim 1, wherein the hidden indicia comprise representations of playing cards displayed by the machine-implemented game on a display associated with the machine-implemented game.

3. The method of claim 1, wherein the machine-implemented game is a form of poker.

4. The method of claim 3, wherein the form of poker is a “Hold'em” type of poker, wherein the machine-implemented game displays representations of private cards representing the hidden indicia to the human player.

5. The method of claim 4, wherein the representations of the private cards of the machine-implemented game are displayed to the human player after the human player terminates play by folding or at the end of the game.

6. The method of claim 1, wherein the step of providing a display of randomly selected indicia indicating a status of the human player's position in the game further comprises displaying representations of randomly selected playing cards.

7. A system for simulating a machine-implemented casino-style game utilizing at least one electronic game machine, the system including:
at least one electronic game machine, the electronic game machine including a display device for displaying indicia representative of a game state, an interface for receiving an input from a human player of the game and a storage device for storing a game algorithm, wherein the game machine further comprises a processor operative with the storage device to implement the game algorithm and operative with the display device to display indicia representative of a game state wherein the game machine is configured to play a primary casino-style machine-implemented game with the human player and a second, ancillary game;
wherein the outcome of the primary casino-style game is based upon a combination of displayed indicia visible to the human player and accessible to the machine and hidden indicia whereby the hidden indicia of the machine-implemented game is not displayed to the human player;
wherein the electronic game machine is further configured to receive at least one wager from the human player entitling the human player to a payout if the player wins one of the primary casino-style game and the ancillary game;
wherein the result of the ancillary game is based upon the hidden indicia representative, at least in part of the game state of the machine-implemented game, and wherein the hidden indicia is not displayed to the human player unless the human player terminates play of the game; and
a central processor connected to the electronic game machine, the central processor operative to receive an input from the electronic game machine corresponding to the outcome of games played on the electronic game machine.

8. The system of claim 7, wherein the machine-implemented game is poker.

9. The system of claim 7, wherein the displayed indicia are visual representations of playing cards.

10. The system of claim 7, further comprising a data interface between each of the electronic game machines and the central processor whereby the outcome of games played by human users of the game machine are transmitted to the central processor.

11. The system of claim 7, wherein the electronic game machine further comprises means for receiving value from a user of the machine.

12. The system of claim 7, wherein the electronic game machine further comprises a stored value card reader whereby value may be transferred from and to the stored value card by the electronic game machine.

13. A system for simulating a machine-implemented casino-style poker game, the system including:
at least one electronic game machine, the electronic game machine including a display device operative to display simulated cards representative of a game state for the casino-style poker machine-implemented game and for a human player of the game;
the electronic game machine including an interface for receiving an input from a human player of the casino-style poker machine-implemented game and a storage device for storing a game algorithm corresponding to the casino-style machine-implemented poker game, wherein the game machine further comprises a processor operative with the storage device to implement the game algorithm and operative with the display device to display simulated cards representative of a game state for the poker machine-implemented game and for a human player of the game and wherein the game machine is configured to play the casino-style poker game with the human player and a second, ancillary game;
wherein the electronic game machine is further configured to receive at least one wager from the human player entitling the human player to a payout if the player wins one of the casino-style poker machine-implemented game and the ancillary game; and
wherein the outcome of the ancillary game is based upon the hidden simulated cards representative, at least in part of the game state of the machine-implemented game, and wherein the hidden simulated cards of the machine-implemented game are not displayed to the human player prior to termination of the game.

14. The system of claim 13, wherein the outcome of the casino-style poker machine-implemented game is based upon a combination of displayed simulated cards and hidden simulated cards representative of the game state of the machine-implemented game and the game state of the human player

15. The system of claim 13, wherein the machine-implemented game is a “Hold'em” type of poker, wherein the machine-implemented game displays representations of private cards representing the hidden simulated cards to the human player.

16. The system of claim 13, wherein the electronic game machine further comprises means for receiving value from a user of the machine.

17. The system of claim 13, wherein the electronic game machine further comprises a stored value card reader whereby value may be transferred from and to the stored value card by the electronic game machine.

18. The system of claim 13, further comprising a central processor connected to the electronic game machine, the central processor operative to receive an input from the electronic game machine corresponding to the outcome of games played on the electronic game machine.
